(19) United States
(12) Patent Application Publication
(10) Pub. No.: US 2026/0214603 A1
(43) Pub. Date: Jul. 23, 2026

(54) SELECTIVE MEASUREMENT OF NEIGHBOR CELLS

(71) Applicant: Samsung Electronics Co., Ltd., Suwon-si (KR)

(72) Inventors: Shiyang Leng, Little Elm, TX (US); Anil Agiwal, McKinney, TX (US); Kyeongin Jeong, Frisco, TX (US)

(21) Appl. No.: 19/445,406

(22) Filed: Jan. 9, 2026

Related U.S. Application Data
(60) Provisional application No. 63/748,327, filed on Jan. 22, 2025.
(60) Provisional application No. 63/775,780, filed on Mar. 21, 2025.
(60) Provisional application No. 63/778,787, filed on Mar. 27, 2025.
(60) Provisional application No. 63/797,677, filed on Apr. 30, 2025.
(60) Provisional application No. 63/846,619, filed on Jul. 18, 2025.

(51) Int. Cl. H04W 56/00; H04W 24/10

(52) U.S. Cl. CPC H04W 56/0015; H04W 24/10; H04W 56/006

(57) ABSTRACT

A method of operating a user equipment (UE) includes receiving system information including (i) a list of synchronization signal block (SSB) measurement timing configurations (SMTCs), and (ii) for each SMTC within the list of SMTCs, location information associated with a respective SMTC. The method also includes selecting, based on the location information, a subset of SMTCs from the list of SMTCs, and measuring at least one neighbor cell on a frequency according to an SMTC within the subset of SMTCs.

### CROSS-REFERENCE TO RELATED APPLICATION(S) AND CLAIM OF PRIORITY

This application claims priority under 35 U.S.C. § 119(e) to U.S. Provisional Patent Application No. 63/748,327 filed on Jan. 22, 2025, U.S. Provisional Patent Appplication No. 63/775,780 filed on Mar. 21, 2025, U.S. Provisional Patent Appplication No. 63/778,787 filed on Mar. 27, 2025, U.S. Provisional Patent Appplication No. 63/797,677 filed on Apr. 30, 2025, and U.S. Provisional Patent Appplication No. 63/846,619 filed on Jul. 18, 2025. The above-identified provisional patent applications are hereby incorporated by reference in their entirety.

### TECHNICAL FIELD

This disclosure relates generally to wireless networks. More specifically, this disclosure relates to selective measurement of neighbor cells.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods for selective measurement of neighbor cells.

In one embodiment, a method of operating a user equipment (UE) is provided. The method includes receiving system information including (i) a list of synchronization signal block (SSB) measurement timing configurations (SMTCs), and (ii) for each SMTC within the list of SMTCs, location information associated with a respective SMTC. The method also includes selecting, based on the location information, a subset of SMTCs from the list of SMTCs, and measuring at least one neighbor cell on a frequency according to an SMTC within the subset of SMTCs.

In another embodiment, a method of operating a base station (BS) is provided. The method includes transmitting system information including (i) a list of SMTCs, and (ii) for each SMTC within the list of SMTCs, location information associated with a respective SMTC. The method also includes receiving, from a UE, a measurement report including a measurement of at least one neighbor cell of the UE on a frequency according to an SMTC within the list of SMTCs.

In yet another embodiment, an electronic device is provided. The electronic device includes at least one processor including processing circuitry, and memory storing instructions. The instructions, when executed by the at least one processor individually or collectively, cause the electronic device to receive system information including (i) a list of SMTCs, and (ii) for each SMTC within the list of SMTCs, location information associated with a respective SMTC. The instructions, when executed by the at least one processor individually or collectively, also cause the electronic device to select, based on the location information, a subset of SMTCs from the list of SMTCs, and measure at least one neighbor cell on a frequency according to an SMTC within the subset of SMTCs.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The following documents and standards descriptions are hereby incorporated by reference into the present disclosure as if fully set forth herein:
[1] 3GPP, TS 38.300v18.4.0, 5G; NR; NR and NG-RAN Overall Description; Stage 2.
[2] 3GPP, TS 38.331v18.4.0, 5G; NR; Radio Resource Control (RRC); Protocol specification.
[3] 3GPP, TS 38.321v18.4.0, NR; Medium Access Control (MAC) protocol specification.
[4] 3GPP, TS 38.304v18.4.0, NR; User Equipment (UE) procedures in Idle mode and RRC Inactive state.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example procedure for selective measurement of neighbor cells according to embodiments of the present disclosure;

FIG. 5 illustrates another example procedure for selective measurement of neighbor cells according to embodiments of the present disclosure;

FIG. 6 illustrates an example procedure for reporting UE assistance information according to embodiments of the present disclosure;

FIGS. 7A and 7B illustrate example direction indications and according to embodiments of the present disclosure

FIG. 8 illustrates an example method for selective measurement of neighbor cells according to embodiments of the present disclosure; and

FIG. 9 illustrates another example method for selective measurement of neighbor cells according to embodiments of the present disclosure.

### DETAILED DESCRIPTION

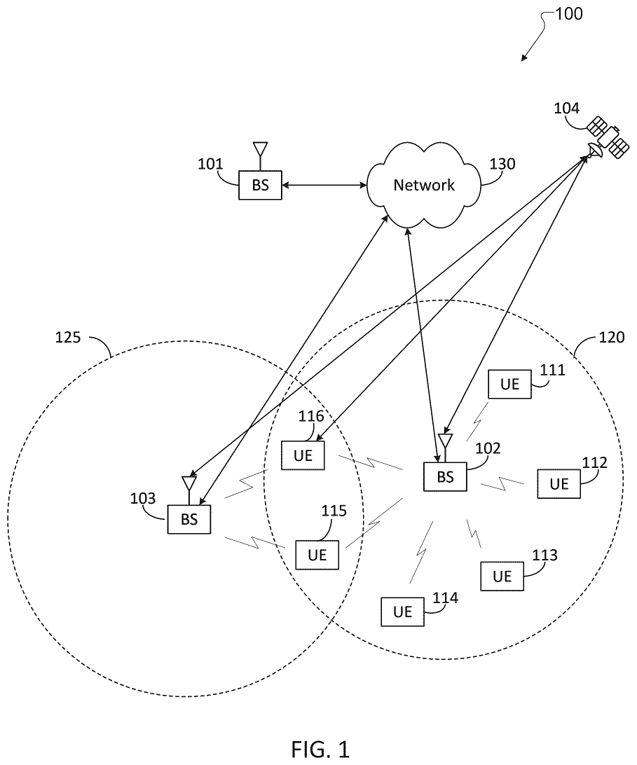

FIGS. 1 through 9, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As discussed in greater detail below, the wireless network 100 may have communications facilitated via one or more communication satellite(s) 104 that may be in orbit over the earth. The communication satellite(s) 104 can communicate directly with the BSs 102 and 103 to provide network access, for example, in situations where the BSs 102 and 103 are remotely located or otherwise in need of facilitation for network access connections beyond or in addition to common fronthaul and/or backhaul connections. The BSs can also be on board the communication satellite(s) 104. Various of the UEs (e.g., as depicted by UE 116) may be capable of at least some direct communication and/or localization with the communication satellite(s) 104.

A non-terrestrial network (NTN) refers to a network, or segment of networks using RF resources on board a communication satellite (or unmanned aircraft system platform) (e.g., communication satellite(s) 104). Taking into account the capabilities of providing wide coverage and reliable service, an NTN is envisioned to ensure service availability and continuity ubiquitously. For instance, an NTN can support communication services in unserved areas that cannot be covered by other terrestrial networks (TNs), in underserved areas that are experiencing limited communication services, for devices and passengers on board moving platforms, and for future railway/maritime/aeronautical communications, etc.

As described in more detail below, one or more of the UEs 111-116 include circuitry, programing, or a combination thereof, for selective measurement of neighbor cells. In certain embodiments, one or more of the gNBs 101-103 includes circuitry, programing, or a combination thereof, to support selective measurement of neighbor cells in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

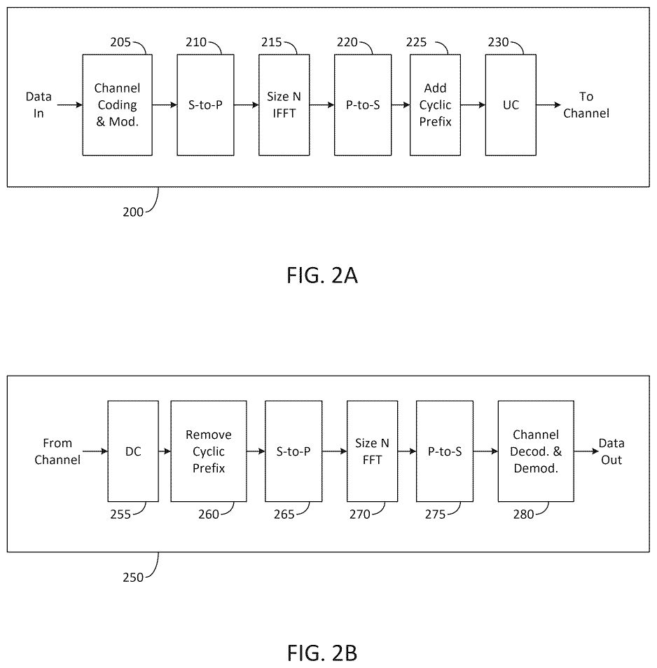

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support selective measurement of neighbor cells as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

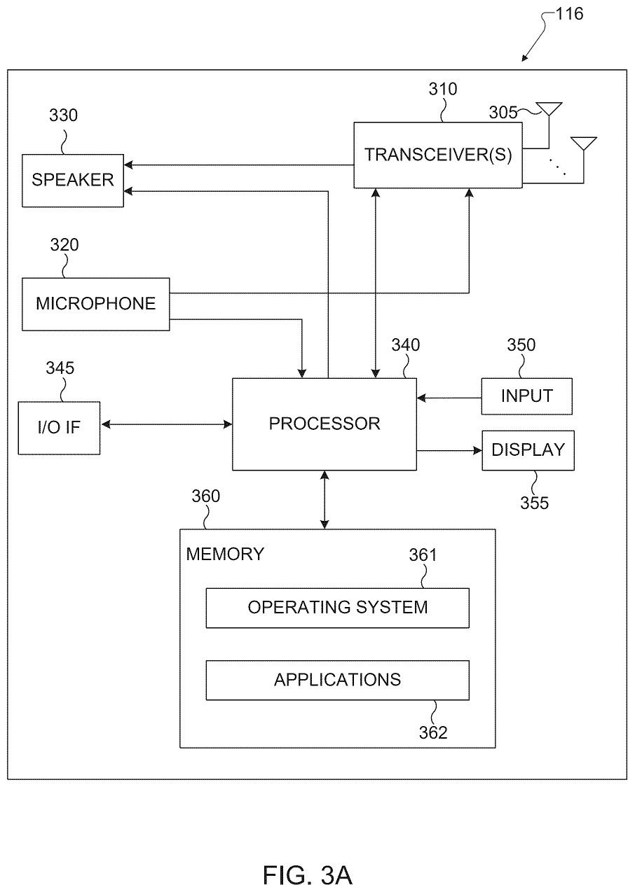

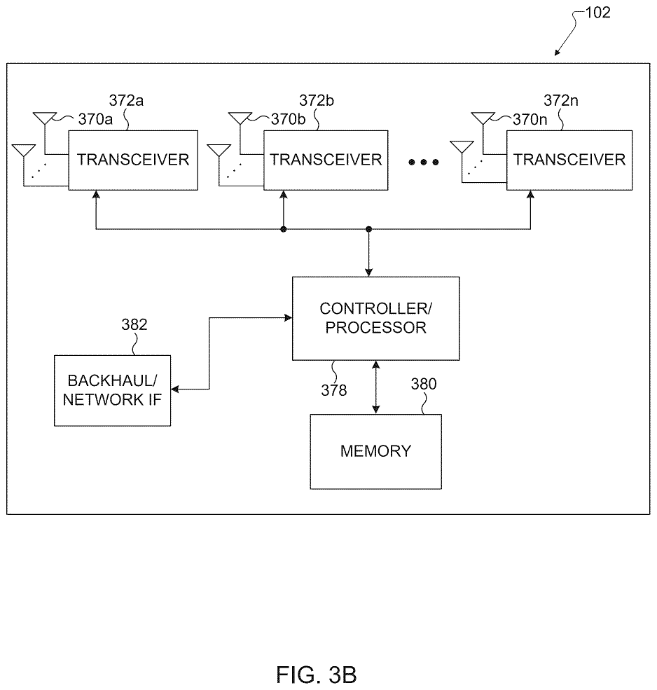

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for selective measurement of neighbor cells as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support selective measurement of neighbor cells as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

The Third-Generation Partnership Project (3GPP) has developed technical specifications and standards to define a fifth generation (5G) radio-access technology, known as 5G New Radio (NR). Mobility handling is a critical aspect in any mobile communication system including a 5G system. In 5G NR, a UE in an RRC_IDLE/INACTIVE state performs cell reselection for mobility purposes. The principles of the cell reselection are as follows. Cell reselection is based on cell-defined synchronization signal blocks (SSBs) located on the synchronization raster. The UE makes measurements of attributes of the serving and neighbor cells to enable the reselection process. For the search and measurement of inter-frequency neighboring cells, the carrier frequencies are indicated. Cell reselection identifies the cell that the UE should camp on. Cell reselection is based on cell reselection criteria which involves measurements of the serving and neighbor cells. Intra-frequency reselection is based on ranking of cells. Inter-frequency reselection is based on absolute priorities where a UE tries to camp on the highest priority frequency available. A Neighbor Cell List (NCL) can be provided by the serving cell to handle specific cases for intra- and inter-frequency neighboring cells. Exclude-lists can be provided to prevent the UE from reselecting to specific intra- and inter-frequency neighboring cells. Allow-lists can be provided to request the UE to reselect to only specific intra- and inter-frequency neighboring cells. Cell reselection can be speed dependent. Service specific prioritization can be provided. Slice-based cell reselection information can be provided to facilitate the UE reselecting a cell that supports specific slices.

In 5G NR, base stations broadcast system information that contains cell reselection information. SIB2 contains cell re-selection information common for intra-frequency, inter-frequency and/or inter-RAT cell re-selection (i.e., applicable for more than one type of cell re-selection but not necessarily all) as well as intra-frequency cell re-selection information other than neighboring cell related. SIB3 contains information about the serving frequency and intra-frequency neighboring cells relevant for cell re-selection (including cell re-selection parameters common for a frequency as well as cell specific re-selection parameters). SIB4 contains information relevant for inter-frequency cell re-selection (i.e., information about other NR frequencies and inter-frequency neighboring cells relevant for cell re-selection), which can also be used for NR idle/inactive measurements. The information element (IE) includes cell re-selection parameters common for a frequency as well as cell specific re-selection parameters. SIB5 contains information about E-UTRA frequencies and E-UTRA neighboring cells relevant for cell re-selection (including cell re-selection parameters common for a frequency as well as cell specific re-selection parameters).

When a UE measures neighbor cells for cell reselection, some neighbor cells may not be measurable for some reasons. For example, some neighbor cells may be switched off at some durations, some neighbor cells with advanced features may not be accessible to, or compatible with, or favored by particular UE implementations, etc. For UE power saving purposes, a UE can measure neighbor cells selectively and avoid unmeasurable neighbor cells in cell reselection. Procedures for a UE to selectively measure neighbor cells for cell reselection are desirable.

Various embodiments of the present disclosure provide UE procedures to selectively measure neighbor cells for cell reselection, which can be applied in TNs and/or non-NTNs. In some embodiments, enhancements on SSB measurement timing configuration (SMTC) may be included. In some embodiments, enhancements on frequency prioritization in cell reselection may be included.

An NTN may provide global, or multi-country coverage. This imposes new challenges as compared to TNs. For example, different policies may apply in different countries. The policies are enforced while the UE is in RRC CONNECTED mode.

The coverage area of one satellite beam may cover (parts of or) more than one country at times, while the satellite field of view may be larger than a country.

The User Location Information (i.e., NTN cell id) may not provide sufficient accuracy to the network to ensure that the correct, country-specific policies can be applied. A more accurate UE location determination scheme for RRC CONNECTED UEs is desirable to enforce country-specific policies.

When a UE cannot report exact position information for some reason, such as GPS loss or lack of position capability, the national granularity can be obtained from the public land mobile network (PLMN) of the TN. For example, the UE can read and report the surrounding cells PLMN. The UE location information can be reported in several ways:
the UE can report the location information to the access and mobility function (AMF) through a non-access stratum (NAS) message (e.g., during the Registration Procedure);
the UE can report the location information to the base station (e.g., gNB) through an access stratum (AS) message if available. Upon the reception of the UE's location information from the UE, the gNB may forward it to the AMF.
   the base station (e.g., gNB) can configure coarseLocationRequest and/or includeCommonLocationInfo in a report configuration, and the UE reports its location in a periodic or event-triggered measurement report.
   the base station (e.g., gNB) can configure coarseLocationRequest in a UEInformationRequest message, and UE reports its location (if available) in the UEInformationResponse message.

As previously noted, when a UE measures neighbor cells for cell reselection, some neighbor cells may not be measurable for some reasons. For example, some neighbor cells may be switched off at some durations, some neighbor cells with advanced features may not be accessible to, or compatible with, or favored by particular UE implementations, etc. To avoid unnecessary measurement and save the UE's power, the network can configure neighbor cells selectively for the UE to measure in connected mode. Procedures for a UE to selectively measure neighbor cells in connected mode in NTNs are desirable. Such procedures can also be applicable to TNs.

Various embodiments of the present disclosure provide procedures to selectively measure neighbor cells in a connected mode, which can be applied in TNs and/or NTNs. In some embodiments, reporting assistance information may be included.

In some embodiments, for neighbor cells on a certain frequency, a list of offsets for the starts of SMTC windows can be configured so that the starts of the SMTC windows shift in time to cover the switching-on duration of a list of neighbor cells. In embodiments such as these, each offset may be associated with one or multiple neighbor cells (e.g., by linking each offset value to a list of physical cell identities [PCIs] of neighbor cells), and different SMTC offsets may be configured for different lists of neighbor cells. A list of new SMTC offsets can be defined in addition to the existing offset values. A UE capability of supporting additional SMTC offsets and/or the number of supported SMTC offsets can be specified, which can be a per UE capability, not distinguished for frequency division duplex (FDD) and time division duplex (TDD) systems, and/or for frequency range 1 (FR1) and frequency range 2 (FR2). In some embodiments, a UE supporting this capability may also support NTNs. In embodiments such as these, the UE can report this capability (e.g., transmitted in UE capability information message) as a response to the network's UE capability inquiry message.

In some embodiments, in addition to the SMTC including one periodicity, one duration, and a list of offset values, a new list of SMTC offsets (e.g., SSB-MTC4ListNew) can be included in a UE dedicated measurement configuration (e.g., measObjectNR for a UE in an RRC_CONNECTED state) and/or in system information (e.g., SIB2, SIB3, SIB4 for a UE in an RRC_IDLE/INACTIVE state). In some embodiments, the new list of SMTC offsets (e.g., SSB-MTC4ListNew) may be optionally present if the existing list of SMTC offsets (e.g., SSB-MTC4List) is present, similar as shown below. Otherwise, in embodiments such as these, the new list of SMTC offsets may be absent.

| MeasObjectNR ::= | SEQUENCE { | |
|---|---|---|
| smtc1 | SSB-MTC | OPTIONAL, -- Cond SSBorAssociatedSSB |
| smtc4list-r17 | SSB-MTC4List-r17 | OPTIONAL, -- Need R |

[[

| | | |
|---|---|---|
| smtc4listNew-r19 | SSB-MTC4ListNew-r19 | OPTIONAL, -- Need R |

]]
}

| | |
|---|---|
| SSB-MTC ::= | SEQUENCE { |
| periodicityAndOffset | CHOICE { |
| sf5 | INTEGER (0..4), |
| sf10 | INTEGER (0..9), |
| sf20 | INTEGER (0..19), |
| sf40 | INTEGER (0..39), |
| sf80 | INTEGER (0..79), |
| sf160 | INTEGER (0..159) |

},

| | |
|---|---|
| duration | ENUMERATED { sf1, sf2, sf3, sf4, sf5 } |

}

| | |
|---|---|
| SSB-MTC4List-r17 ::= | SEQUENCE (SIZE(1..3)) OF SSB-MTC4-r17 |
| SSB-MTC4ListNew-r19 ::= | SEQUENCE (SIZE(1..5)) OF SSB-MTC4-r17 |
| SSB-MTC4-r17 ::= | SEQUENCE { |
| pci-List-r17 | SEQUENCE (SIZE (1..maxNrofPCIsPerSMTC)) OF PhysCellId |
| offset-r17 | INTEGER (0..159) |

}

In some embodiments (such as above), if smtc4list is present or if SSB-MTC4List2 is also present, for cells indicated in the pci-List parameter in each SSB-MTC4 element of the list in the same MeasObjectNR, the UE shall setup an additional SMTC in accordance with the received offset parameter in each SSB-MTC4 configuration and use the duration parameter and periodicity (derived from parameter periodicityAndOffset) from the smtc1 configuration. The first subframe of each SMTC occasion occurs at a system frame number (SFN) and subframe of the NR SpCell meeting the following condition: SFN mod T=(FLOOR (Offset/10)), with T=CEIL(Periodicity/10), and if the Periodicity is larger than sf5, subframe=Offset mod 10; else, subframe=Offset or (Offset+5).

In some embodiments, one or multiple SMTCs (e.g., smtcNew) can be included in a UE dedicated measurement configuration (e.g., measObjectNR for a UE in an RRC_CONNECTED state) and/or in system information (e.g., SIB2, SIB3, SIB4 for a UE in an RRC_IDLE/INACTIVE state), so that new sets of parameters, including periodicity, duration and offset(s), are configured in additional to the existing SMTC (e.g., smtc1), similar as shown below.

| MeasObjectNR ::= | SEQUENCE { | |
|---|---|---|
| smtc1 | SSB-MTC | OPTIONAL, -- Cond SSBorAssociatedSSB |

[[

| | | |
|---|---|---|
| smtcNew-r19 | SSB-MTC-ListNew-r19 | OPTIONAL, -- Need R |

]]
}

| | |
|---|---|
| SSB-MTC ::= | SEQUENCE { |
| periodicityAndOffset | CHOICE { |
| sf5 | INTEGER (0..4), |
| sf10 | INTEGER (0..9), |
| sf20 | INTEGER (0..19), |
| sf40 | INTEGER (0..39), |
| sf80 | INTEGER (0..79), |
| sf160 | INTEGER (0..159) |

},

| | |
|---|---|
| duration | ENUMERATED { sf1, sf2, sf3, sf4, sf5 } |

}

| | |
|---|---|
| SSB-MTC-ListNew-r19 ::= | SEQUENCE (SIZE(1..maxNrofSMTCsNew)) OF SSB-MTC- |

New-r19

| | |
|---|---|
| SSB-MTC-New-r19 ::= | SEQUENCE { |
| periodicityAndOffset | CHOICE { |
| sf5 | INTEGER (0..4), |
| sf10 | INTEGER (0..9), |
| sf20 | INTEGER (0..19), |
| sf40 | INTEGER (0..39), |
| sf80 | INTEGER (0..79), |
| sf160 | INTEGER (0..159) |

},

| | |
|---|---|
| duration | ENUMERATED { sf1, sf2, sf3, sf4, sf5 } |
| pci-List-r17 | SEQUENCE (SIZE (1..maxNrofPCIsPerSMTC)) OF PhysCellId |

}

In some embodiments (such as above), if smtcNew is present, for cells indicated in the pci-List parameter in each SSB-MTC-New element of the list in the same MeasObjectNR, the UE shall setup an additional SS block measurement timing configuration in accordance with the received periodicityAndOffset parameter in each SSB-MTC-New configuration and use the duration from each SSB-MTC-New configuration. The first subframe of each SMTC occasion occurs at an SFN and subframe of the NR SpCell meeting the following condition: SFN mod T=(FLOOR (Offset/10)), with T=CEIL(Periodicity/10), and if the Periodicity is larger than sf5, subframe=Offset mod 10; else, subframe=Offset or (Offset+5).

In some embodiments, the new SMTC offset (e.g., SSB-MTC4ListNew) provided in system information (e.g., SIB2, SIB3, SIB4) may be based on the assumption that the gNB-UE propagation delay difference between the serving cell and neighbor cells equals 0 ms, and the UE can adjust the actual offset based on the actual propagation delay difference. In some embodiments, for a UE that supports less SMTCs than what is included in an SMTC list, the UE is responsible for selecting which SMTCs to consider.

In some embodiments, location information and/or time information associated to an SMTC can be provided. In embodiments such as these, a UE capability of supporting location- and/or time-based SMTC can be specified, which can be a per UE capability, not distinguished for FDD and TDD systems, and/or for FR1 and FR2. In some embodiments, a UE supporting this capability can also support NTNs. In some embodiments, a UE can report its capability of supporting location- and/or time-based SMTCs (e.g., transmitted in a UE capability information message) as a response to the network's UE capability inquiry message.

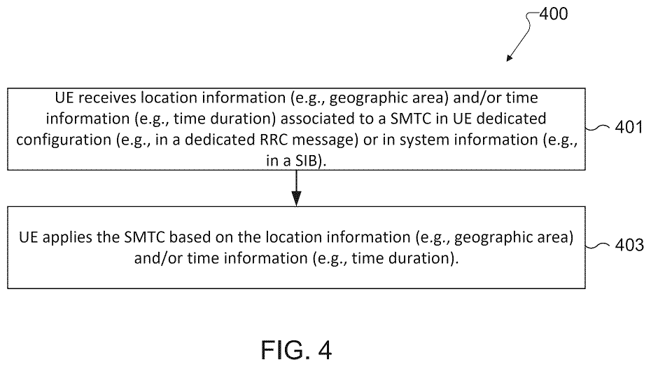

FIG. 4 illustrates an example procedure for selective measurement of neighbor cells 400 according to embodiments of the present disclosure. An embodiment of the method illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of a procedure for selective measurement of neighbor cells could be used without departing from the scope of this disclosure.

In the example of FIG. 4, the procedure 400 begins at operation 401. At operation 401, a UE (such as UE 116 of FIG. 1) receives (for example, from a BS such as gNB 102 of FIG. 1) location information (e.g., geographic area) and/or time information (e.g., time duration) associated to a SMTC in a UE dedicated configuration (e.g., in a dedicated RRC message) or in system information (e.g., in a SIB).

At operation 403, the UE applies the SMTC based on the location information (e.g., geographic area) and/or time information (e.g., time duration). In some embodiments, the location information may indicate a geographic area for which a SMTC is applied. For example, the location information can include a reference location (e.g., coordinates of a center point) and/or a radius (e.g., a distance threshold). In some embodiments, the center coordinates can be signaled as a bit string, (e.g., in the format of the parameter “Ellipsoid-Point”). In embodiments such as these, the first/leftmost bit of the first octet contains the most significant bit. The radius indicates a distance from the center coordinates (e.g., a distance threshold), which can be signaled as an integer value in a unit of meters. In some embodiments, the time information may indicate a duration for which an SMTC is applied. The time information can include a start time and a duration, or alternatively, a start time and an end time. The reference time of the start/end time can be the uplink time synchronization reference point of the serving cell in an NTN.

Although FIG. 4 illustrates one example procedure for selective measurement of neighbor cells 400, various changes may be made to FIG. 4. For example, while shown as a series of operations, various operations in FIG. 4 could overlap, occur in parallel, occur in a different order, occur any number of times, be omitted, or replaced by other operations.

In some embodiments, if location information is provided associated to a SMTC and the UE's location is known, and if the UE determines that it is located within the indicated geographic area (e.g., its distance to the reference location is smaller than the threshold), the UE applies the SMTC and/or sets up the SMTC in accordance with the received parameters (e.g., periodicity, duration and offsets), and/or the UE can measure the frequency for which the SMTC applies. In some embodiments, if location information is provided associated to a SMTC and the UE's location is known, and if the UE determines that it does not locate within the indicated geographic area (e.g., its distance to the reference location is not smaller than the threshold), the UE may not apply the SMTC, and/or the UE may not measure the frequency for which the SMTC applies. In some embodiment, the location information may be provided per neighbor cell included in the SMTC. In embodiments such as these, if the UE is located within the indicated geographic area of at least one neighbor cell associated to the SMTC (e.g., the UE's distance to the reference location of at least one neighbor cell associated to the SMTC is smaller than the threshold), the UE applies the SMTC and/or sets up the SMTC in accordance with the received parameters (e.g., periodicity, duration and offsets), and/or the UE measures the neighbor cells of which geographic area the UE is located in (e.g., to which the UE's distance is smaller than the threshold). If the UE does not locate within the indicated geographic area of any neighbor cell associated to the SMTC (e.g., the UE's distance to none of the neighbor cell's reference location associated to the SMTC is smaller than the threshold), the UE does not apply the SMTC, and/or the UE does not measure any neighbor cell configured in the SMTC.

In some embodiments, if time information is provided associated to a SMTC and if the UE determines the current time is within the indicated time duration, the UE applies the SMTC and/or sets up the SMTC in accordance with the received parameters (e.g., periodicity, duration and offsets), and/or the UE can measure the frequency for which the SMTC applies. In some embodiments, if time information is provided associated to a SMTC and if the UE determines the current time is not within the indicated time duration, the UE may not apply the SMTC, and/or the UE may not measure the frequency for which the SMTC applies. In some embodiments, the time information may be provided per neighbor cell included in the SMTC. In embodiments such as these, if the current time is within the indicated duration of at least one neighbor cell associated to the SMTC, the UE applies the SMTC and/or sets up the SMTC in accordance with the received parameters (e.g., periodicity, duration and offsets), and/or the UE can measure the neighbor cells for which the current time is within the associated duration. If the current time is not within any of the indicated durations of neighbor cells associated to the SMTC, the UE does not apply the SMTC, and/or the UE does not measure any neighbor cell configured in the SMTC.

In some embodiments, if both location information and time information are provided associated to a SMTC and if the UE determines it is located within the indicated geographic area (e.g., its distance to the reference location is smaller than the threshold), and the current time is within the indicated time duration, the UE applies the SMTC and/or sets up the SMTC in accordance with the received parameters (e.g., periodicity, duration and offsets), and/or the UE can measure the frequency for which the SMTC applies. In some embodiments, if both location information and time information are provided associated to a SMTC, and if the UE determines it does not locate within the indicated geographic area (e.g., its distance to the reference location is not smaller than the threshold), or the current time is not within the indicated time duration, the UE may not apply the SMTC, and/or the UE may not measure the frequency for which the SMTC applies. In some embodiments, both location information and time information may be provided per neighbor cell included in the SMTC. In embodiments such as these, if the UE is located within the indicated geographic area of at least one neighbor cell associated to the SMTC (e.g., the UE's distance to the reference location of at least one neighbor cell associated to the SMTC is smaller than the threshold), and if the current time is within the indicated duration of the same neighbor cell, the UE applies the SMTC and/or sets up the SMTC in accordance with the received parameters (e.g., periodicity, duration and offsets), and/or the UE can measure the neighbor cells of which geographic area the UE is located in (e.g., to which the UE's distance is smaller than the threshold), and for which the current time is within the associated duration. If the UE does not locate within the indicated geographic area of any neighbor cell associated to the SMTC (e.g., the UE's distance to none of the neighbor cell's reference locations associated to the SMTC is smaller than the threshold), or if the current time is not within any of the indicated durations of neighbor cells associated to the SMTC, the UE does not apply the SMTC, and/or the UE does not measure any neighbor cell configured in the SMTC.

In some scenarios, for cells operating with an advanced feature, UEs not supporting such an advanced feature may not be able to access or be compatible with or favor such advanced cells. In some embodiments, such UEs can be informed to selectively measure neighbor cells so that measurement on inaccessible/incompatible/unfavored neighbor cells can be avoided or deprioritized. For example, DL coverage enhancement (CE) is an advanced feature, and a DL CE cell is an advanced cell. However, the selective measurements as described herein also be applied to other types of features/cells. In some embodiments, the capability of supporting an advanced feature can be defined to be per UE or per frequency band or per frequency band combination, which can be (not) distinguished for FDD and TDD systems, and/or for FR1 and FR2. In some embodiments, a UE can report its capability of supporting an advanced feature (e.g., in a UE capability information message) as a response to the network's UE capability inquiry message.

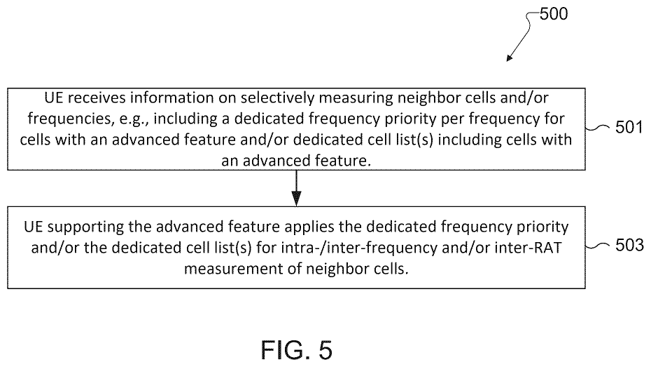

FIG. 5 illustrates another example procedure for selective measurement of neighbor cells 500 according to embodiments of the present disclosure. An embodiment of the method illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a procedure for selective measurement of neighbor cells could be used without departing from the scope of this disclosure.

In the example of FIG. 5, the procedure 500 begins at operation 501. At operation 501, a UE (such as UE 116 of FIG. 1) receives information on selectively measuring neighbor cells and/or frequencies (e.g., including a dedicated frequency priority per frequency for cells with an advanced feature and/or dedicated cell list(s) including cells with an advanced feature). The UE can receive such information in a UE dedicated RRC message (e.g., RRC reconfiguration message or RRC release message) and or in common signaling (e.g., system information).

At operation 503, the UE, supporting the advanced feature, applies the dedicated frequency priority and/or the dedicated cell list(s) for intra-/inter-frequency and/or inter-RAT measurement of neighbor cells.

Although FIG. 5 illustrates one example procedure for selective measurement of neighbor cells 500, various changes may be made to FIG. 5. For example, while shown as a series of operations, various operations in FIG. 5 could overlap, occur in parallel, occur in a different order, occur any number of times, be omitted, or replaced by other operation.

In some embodiments, the network can configure a new frequency priority per frequency for inter-frequency measurement of advanced cells in cell reselection, which is in addition to the existing frequency priority for inter-frequency measurement of cells not operating with the advanced feature. The new frequency priority can be included in system information (e.g., SIB4) or in an RRC release message. In some embodiments, a UE supporting the advanced feature applies the frequency priority for the frequency of the advanced cells and ignores the frequency priority for the frequency of the cells not operating with the advanced feature. In some embodiments, for an NR inter-frequency or inter-RAT frequency with a reselection priority higher than the reselection priority of the current NR frequency, the UE shall perform measurements of higher priority NR inter-frequency or inter-RAT frequencies. In some embodiments, for a NR inter-frequency with an equal or lower reselection priority than the reselection priority of the current NR frequency and for inter-RAT frequency with lower reselection priority than the reselection priority of the current NR frequency, the UE decides to perform measurements of NR inter-frequency cells of equal or lower priority, or inter-RAT frequency cells of lower priority based on rules, as follows:
For the following parameters:
Srxlev: cell selection RX level value (dB)
Squal: cell selection quality value (dB)
S_{nonIntraSearchP}: this specifies the Srxlev threshold (in dB) for NR inter-frequency and inter-RAT measurements.
S_{nonIntraSearchQ}: this specifies the Squal threshold (in dB) for NR inter-frequency and inter-RAT measurements.
distanceThresh: this indicates the distance threshold from the serving cell reference location to be used in location-based measurement initiation.
movingReferenceLocation: this indicates the reference location of the serving cell at a time reference, to be used in location-based measurement initiation for NTN Earth-moving cell.
referenceLocation: this indicates the reference location of the serving cell to be used in location-based measurement initiation for NTN (quasi-)Earth-fixed cell.
   If the serving cell fulfils Srxlev>S_{nonIntraSearchP} and Squal>S_{nonIntraSearchQ}:
      If distanceThresh and referenceLocation are broadcasted in SIB19, and if the UE supports location-based measurement initiation for an NTN (quasi-)Earth-fixed cell and has obtained its UE location information, if the distance between UE and the serving cell reference location referenceLocation is shorter than distanceThresh, the UE may choose not to perform measurements of NR inter-frequency cells of equal or lower priority, or inter-RAT frequency cells of lower priority. Otherwise, the UE shall perform measurements of NR inter-frequency cells of equal or lower priority, or inter-RAT frequency cells of lower priority.
      Otherwise, if distanceThresh and movingReferenceLocation are broadcasted in SIB19, and if UE supports location-based measurement initiation for NTN Earth-moving cell and has obtained its location information, if the distance between the UE's location and the serving cell reference location determined based on movingReferenceLocation is shorter than distanceThresh, the UE may not perform measurements of NR inter-frequency cells of equal or lower priority, or inter-RAT frequency cells of lower priority. Otherwise, the UE shall perform measurements of NR inter-frequency cells of equal or lower priority, or inter-RAT frequency cells of lower priority.
      Otherwise, the UE may choose not to perform measurements of NR inter-frequency cells of equal or lower priority, or inter-RAT frequency cells of lower priority;
   Otherwise, the UE shall perform measurements of NR inter-frequency cells of equal or lower priority, or inter-RAT frequency cells of lower priority.

For the following parameters:
Treselection_{RAT}: this specifies the cell reselection timer value. For each target NR frequency and for each RAT other than NR, a specific value for the cell reselection timer is defined, which is applicable when evaluating reselection within NR or towards other RAT (i.e., Treselection_{RAT} for NR is Treselection_{NR}, for E-UTRAN Treselection_{EUTRA}).
Thresh_{X, HighP}: this specifies the Srxlev threshold (in dB) used by the UE when reselecting towards a higher priority RAT/frequency than the current serving frequency. Each frequency of NR and E-UTRAN might have a specific threshold.
Thresh_{X, HighQ}: this specifies the Squal threshold (in dB) used by the UE when reselecting towards a higher priority RAT/frequency than the current serving frequency. Each frequency of NR and E-UTRAN might have a specific threshold.
Thresh_{X, LowP}: this specifies the Srxlev threshold (in dB) used by the UE when reselecting towards a lower priority RAT/frequency than the current serving frequency. Each frequency of NR and E-UTRAN might have a specific threshold.
Thresh_{X, LowQ}: this specifies the Squal threshold (in dB) used by the UE when reselecting towards a lower priority RAT/frequency than the current serving frequency. Each frequency of NR and E-UTRAN might have a specific threshold.
Thresh_{Serving, LowP}: this specifies the Srxlev threshold (in dB) used by the UE on the serving cell when reselecting towards a lower priority RAT/frequency.
Thresh_{Serving, LowQ}: this specifies the Squal threshold (in dB) used by the UE on the serving cell when reselecting towards a lower priority RAT/frequency.
   If thresh_{ServingLowQ} is broadcast in system information and more than 1 second has elapsed since the UE camped on the current serving cell, cell reselection to a cell on a higher priority NR frequency or inter-RAT frequency than the serving frequency shall be performed if a cell of a higher priority NR or EUTRAN RAT/frequency fulfils Squal>Thresh_{X, HighQ} during a time interval Treselection_{RAT}.
   Otherwise, cell reselection to a cell on a higher priority NR frequency or inter-RAT frequency than the serving frequency shall be performed if (i) a cell of a higher priority RAT/frequency fulfils Srxlev>Thresh_{X, HighP} during a time interval Treselection_{RAT}, and (ii) more than 1 second has elapsed since the UE camped on the current serving cell.
   If thresh_{ServingLowQ} is broadcast in system information and more than 1 second has elapsed since the UE camped on the current serving cell, cell reselection to a cell on a lower priority NR frequency or inter-RAT frequency than the serving frequency shall be performed if the serving cell fulfils Squal<Thresh_{Serving, LowQ} and a cell of a lower priority NR or E-UTRAN RAT/frequency fulfils Squal>Thresh_{X, LowQ} during a time interval Treselection_{RAT}.
   Otherwise, cell reselection to a cell on a lower priority NR frequency or inter-RAT frequency than the serving frequency shall be performed if (i) the serving cell fulfils Srxlev<Thresh_{Serving, LowP} and a cell of a lower priority RAT/frequency fulfils Srxlev>Thresh_{X, LowP} during a time interval Treselection_{RAT}, and (ii) more than 1 second has elapsed since the UE camped on the current serving cell.
   Cell reselection to a higher priority RAT/frequency shall take precedence over a lower priority RAT/frequency if multiple cells of different priorities fulfil the cell reselection criteria. If more than one cell meets the above criteria, the UE shall reselect a cell as follows:
      If the highest-priority frequency is an NR frequency, the highest ranked cell among the cells on the highest priority frequency(ies) meeting the criteria;
      If the highest-priority frequency is from another RAT, the strongest cell among the cells on the highest priority frequency(ies) meeting the criteria of that RAT.

In some embodiments, the network can configure a new excluded cell list per frequency for intra-frequency and/or inter-frequency measurement for advanced cells for cell reselection, which is in addition to the existing excluded cell list for intra-/inter-frequency measurement of cells not operating with the advanced feature. The new excluded cell list can be included in system information (e.g., SIB2 for intra-frequency measurement and/or SIB4 for inter-frequency measurement) or in an RRC release message. In some embodiments, a UE supporting the advanced feature applies the excluded cell list for the advanced cells and ignores the excluded cell list for the cells not operating with the advanced feature. In some embodiments, a UE supporting the advanced feature shall not consider any cells in the new excluded list as a candidate for cell reselection. In some embodiments, a UE supporting the advanced feature may consider cells in the excluded cell list for the cells not operating with the advanced feature as a candidate for cell reselection.

In some embodiments, the network can configure a new allowed cell list per frequency for intra-frequency and/or inter-frequency measurement for advanced cells for cell reselection, which is in addition to the existing allowed cell list for intra-/inter-frequency measurement of cells not operating with the advanced feature. The new allowed cell list can be included in system information (e.g., SIB2 for intra-frequency measurement and/or SIB4 for inter-frequency measurement) or in RRC release message. In some embodiments, a UE supporting the advanced feature applies the allowed cell list for the advanced cells and ignores the allowed cell list for the legacy cells. In some embodiments, The UE supporting the advanced feature shall consider only the cells in the new allowed list, if configured, as candidates for cell reselection.

In some embodiments, the network can provide a list of advanced cells per frequency for intra-frequency measurement and/or inter-frequency measurement. In some embodiments, a UE supporting the advanced feature can measure only the advanced cells included in the list for the corresponding frequency. A UE not supporting the advanced feature can exclude the advanced cells included in the list when measuring the corresponding frequency for cell reselection. In some embodiments, a UE supporting the advanced feature considers the frequency of the advanced cells included in the list to be the highest priority (i.e., higher than any other network configured priorities). In some embodiments, a UE not supporting the advanced feature considers the frequency of the advanced cells included in the list to be the lowest priority (i.e., lower than any other network configured priorities).

In some embodiments the advanced feature may refer to an extended SSB periodicity, and the advanced cell may refer to a cell broadcasting SSB burst with the extended periodicity. In embodiments such as these, for each neighbor cell in a neighbor cell list for cell reselection (e.g., in a SIB for intra-frequency measurement and/or in a SIB for inter-frequency measurement), the network can provide the SSB periodicity value or an explicit or implicit indication of SSB periodicity extension. In some embodiments, a UE supporting the SSB periodicity extension can measure only the cells indicated with extended SSB periodicity for the corresponding frequency. In some embodiments, a UE not supporting the SSB periodicity extension can exclude cells indicated with extended SSB periodicity when measuring the corresponding frequency for cell reselection. In some embodiments, a UE supporting the SSB periodicity extension considers the frequency of the cells indicated with extended SSB periodicity to be the highest priority (i.e., higher than any other network configured priorities). In some embodiments, a UE not supporting the SSB periodicity extension considers the frequency of the cells indicated with extended SSB periodicity to be the lowest priority (i.e., lower than any other network configured priorities).

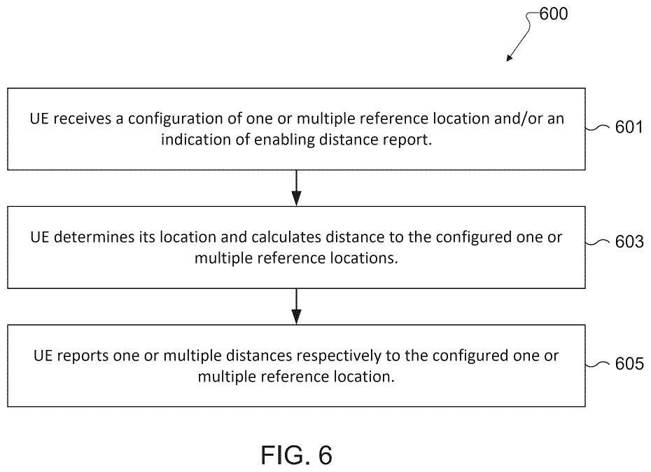

In some embodiments, UE assistance information (e.g., distance) to a reference location can be reported based on a network request, similar as shown in FIG. 6.

FIG. 6 illustrates an example procedure for reporting UE assistance information 600 according to embodiments of the present disclosure. An embodiment of the procedure illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a procedure for reporting UE assistance information could be used without departing from the scope of this disclosure.

In the example of FIG. 6, the procedure 600 begins at operation 601. At operation 601, a UE (such as UE 116 of FIG. 1) receives (for example, from a BS such as gNB 102 of FIG. 1) a configuration of one or multiple reference locations and/or an indication of enabling a distance assistance information report.

At operation 603, if refence location(s) is configured, the UE determines its location, and/or calculates distances to the configured one or multiple configured reference locations. At operation 605, the UE reports assistance information which can include one or multiple distances respectively to the one or multiple configured reference locations.

Although FIG. 6 illustrates one example procedure for reporting UE assistance information 600, various changes may be made to FIG. 6. For example, while shown as a series of operations, various operations in FIG. 6 could overlap, occur in parallel, occur in a different order, occur any number of times, be omitted, or replaced by other operations.

In some embodiments, the network can configure an assistance information report (e.g., distance report) in a UE dedicated configuration (e.g., in a UEInformationRequest message, and/or in measurement object/report configuration). In embodiments such as these, one or multiple reference locations can be configured in a list. A reference location can associated to one or multiple of serving cells and/or neighbor cells. Each reference location can be indicated the same format as the parameter “Ellipsoid-Point.” For example, the first/leftmost bit of the first octet may contain the most significant bit. Each reference location can be identified by an index (e.g., ordinal position in the list) or an identifier (e.g., reference location ID). In some embodiments, the presence of the reference location(s) implicitly indicates the request of the distance report. Alternatively, a one-bit indication of assistance information report request (e.g., distance report request) can be included explicitly.

In some embodiments, if a list of reference locations is present and/or an assistance information report (e.g., a distance report) is requested in the UE assistance information request message (e.g., in a UEInformationRequest message), the UE reports assistance information (e.g., distance(s)) in UE assistance information report message (e.g., UEInformationResponse). For instance, upon receiving the UEInformationRequest message, after successful security activation, if the assistance information report request (e.g., distance request) is set to true or if reference location(s) for the assistance information report (e.g., distance report) is configured, the UE includes assistance information (e.g., a distance for each configured reference location) in the UEInformationResponse message. The assistance information (e.g., distances) can be included in the same order as the reference locations in the reference location list. Alternatively, if an ID is configured for each reference location, each assistance information (e.g., distance) and the corresponding reference location ID are included.

In some embodiments, if a list of reference locations is present and/or an assistance information request (e.g., a distance report) is requested in a measurement object/report configuration for a periodic or event-triggered report, the UE reports the assistance information (e.g., distance(s)) in a measurement result message periodically or triggered by event(s).

In some embodiments, measurement configuration may include the following parameters:
Measurement objects: A list of objects on which the UE shall perform the measurements. network can configure distance and/or location as trigger quantity.
Reporting configurations: A list of reporting configurations where there can be one or multiple reporting configurations per measurement object. Each measurement reporting configuration includes the following:
   Reporting criterion: The criterion that triggers the UE to send a measurement report. This can either be periodic or a single event description.
   Reporting format: The quantities per cell and per beam that the UE includes in the measurement report (e.g., RSRP) and other associated information such as the maximum number of cells and the maximum number beams per cell to report.
Measurement identities (measId): For measurement reporting, a list of measurement identities where each measurement identity links one measurement object with one reporting configuration.

In some embodiments, for each measId, if the reportType for the associated reportConfig is periodic and/or eventTriggered, if the measObject is associated to a report configuration including a distance/time/location-based event (e.g., eventD1/D2/T1) or a distance report request, the UE performs the corresponding measurements associated to neighboring cells on the frequencies indicated in the concerned measObject. When performing the measurement, the UE does not apply layer 3 filtering to derive the location and/or distance measurement. The UE performs the evaluation of reporting criteria. If a periodic report type is configured in the associated reporting configuration, the UE reports periodically. If an event-triggered report type is configured in the associated reporting configuration, the UE evaluates the associated trigger event (e.g., eventD1/D2/T1) and reports once the associated event is fulfilled.

In some embodiments, if a distance report request is configured in the corresponding report configuration for this measId, the UE includes a distance for each configured reference location in the measurement object/report configuration. The distances can be included in the same order as the reference locations in the reference location list. Alternatively, in some embodiments, if an ID is configured for each reference location, each distance and the corresponding reference location ID are included.

In some embodiments, the network receives the distance report from UE, and can estimate the UE location. Based on UE location, the network can configure measurement for neighbor cell(s) that are close to UE and/or configure SMTCs for the selected neighbor cells.

In some embodiments, the network can configure a list of one or multiple SMTCs for neighbor cells measurement. In embodiments such as these, the UE may select a subset of SMTCs and/or report to the network the selected SMTCs (e.g., by indicating an index/ID associated to the SMTC in a measurement result message). In some embodiments, an integer number N is configured, which indicates the least number of SMTCs to be selected for neighbor cell measurement. In embodiments such as these, the UE can select N SMTCs up to implementation. In some embodiments, each SMTC can be configured with a reference location and a distance threshold. Based on the UE location, the UE selects one or more SMTCs for neighbor cell measurement. If the UE distance to the reference location associated to an SMTC is smaller than a distance threshold, the UE selects that SMTC and/or applies the measurement configuration associated to the SMTC for neighbor cell measurement (e.g., for cell reselection).

As described herein the “distance” (e.g., with respect to a reference location) can refer to a distance level/range. For a distance level/range, the UE calculates the distance between the UE location and the reference location, and then determines the distance belongs to which distance range. The network may configure a list of distances with respect to a reference location. For example, for a reference location with coordinates (x, y, z), a list of distances {D1, D2, D3 . . . } in an increasing order can be configured. In some embodiments, a UE determines its distance D belongs to range D1 if D is smaller than or equal to D1, range D2 if D is smaller than or equal to D2 but larger than D1, range D3 if D is smaller than or equal to D3 but larger than D2, and so on. If a distance report is requested, the UE reports the corresponding distance level/range. In another example, if a distance report is requested, the UE reports the index of the corresponding distance level/range, where the index reflects the ordinal position in the list. In some embodiments, each distance in the list may be assigned with an ID, and if a distance report is requested, the UE reports the ID of the corresponding distance level/range.

In some embodiments, the assistance information to be reported by UE can be one or multiple indexes or IDs of the configured reference location. In some embodiments, the UE may report the index/ID of the closeted reference location. In some embodiments, the UE may report a list of the indexes/IDs of the configured reference location to the UE's location, and the indexes/IDs can be listed in an order from the closest reference location to the farthest reference location. In some embodiments, a UE can report up to N indexes/IDs where N is a configured value. In some embodiments, a UE can report all indexes/IDs of the configured reference location.

In some embodiments, the network can configure multiple SMTCs for each frequency for neighbor cell measurement. In embodiments such as these, the UE can select by implementation a subset of the configured SMTCs up to its capability. The network can provide some assistance information for SMTC selection. The assistance information can include location information related to neighbor cells and/or SMTCs. The assistance information (e.g., location information) can assist the UE to know which neighbor cells associated to certain SMTCs are close to the UE's location so that the UE only needs to apply that SMTC(s) for neighbor cell measurement. To this end, the association between geographic areas and SMTCs can be provided. The geographic areas can be indicated explicitly or implicitly.

In some embodiments, one or multiple reference locations are provided associated to a SMTC. A reference location indicates a point (e.g., center point) in the area of one or multiple adjacent neighbor cells. If the serving cell is an earth moving cell, the reference location(s) are given for the epoch time, and the UE can derive the real-time reference location(s) based on serving cell ephemeris provided by the network. The UE can apply the reference location information when it has a valid UE location, determine the close reference location(s), and apply the associated SMTC(s) to measure the neighbor cells for the selected SMTC(s). A reference location can be indicated similar as the format of the parameter “Ellipsoid-Point.”

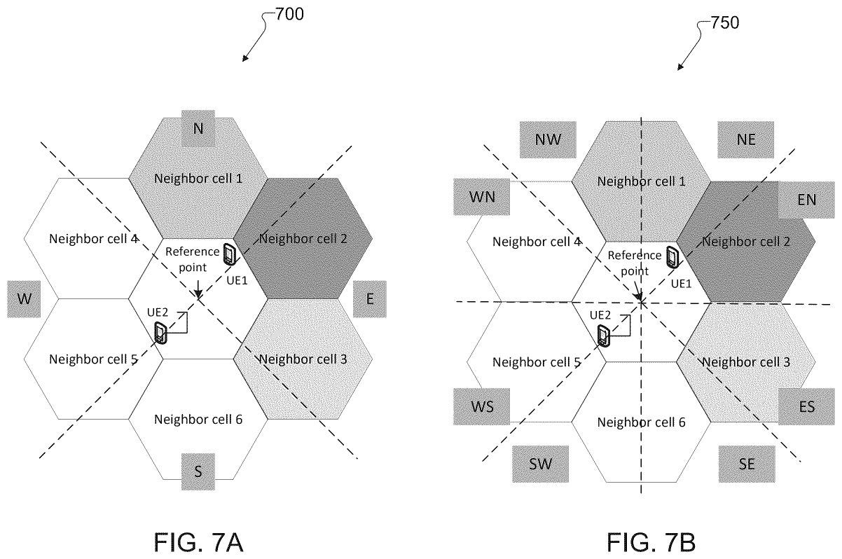

In some embodiments, an area/direction bitmap with respect to a reference location is provided associated to a SMTC. In embodiments such as these, each bit in the bitmap indicates an area/direction with respective to a reference location. For example, one or multiple bits of value 1 in a 4-bit bitmap can indicate one or multiple areas/directions of north, west, south, east, respectively. In another example, one or multiple bits of value 1 in an 8-bit bitmap can indicate one or multiple areas/directions of north-west (NW), west-north (WN), west-south (WS), south-west (SW), south-east (SE), east-south(ES), east-north (EN), north-east (NE), respectively. Examples are shown in FIGS. 7A and 7B.

FIGS. 7A and 7B illustrate example direction indications 700 and 750 according to embodiments of the present disclosure. The embodiment of direction indications of FIG. 7 is for illustration only. Different embodiments of direction indications could be used without departing from the scope of this disclosure.

In the example of FIG. 7A, multiple areas/directions of north (N), west (W), south(S), and east (E), respectively are shown with respect to a reference point in a cell in which a UE1 and UE2 are operating. These directions can be indicated, for example, with a 4-bit bitmap.

In the example of FIG. 7B, multiple areas/directions of north-west (NW), west-north (WN), west-south (WS), south-west (SW), south-east (SE), east-south(ES), east-north (EN), and north-east (NE), respectively are shown with respect to a reference point in a cell in which a UE1 and UE2 are operating. These directions can be indicated, for example, with an 8-bit bitmap.

Although FIGS. 7A and 7B illustrate example direction indications 700 and 750, various changes may be made to FIG. 7A and &B. For example, various changes to number of directions could be made, different directions could be indicated, etc. according to particular needs.

In some embodiments, for a SMTC, a bitmap with 4 bits or 8 bits can be configured and a reference point can be indicated. For a 4-bit bitmap, the bits from the left to the right can correspond to north, west, south, east, respectively, similar as shown in FIG. 7A. For an 8-bit bitmap, the bits from the left to the right can correspond to NW, WN, WS, SW, SE, ES, EN, NE, respectively, similar as shown in FIG. 7B. In embodiments such as these, a bit of value 1 indicates that the area in the indicated direction with respect to the reference location is associated to the SMTC. Similarly, a bit of value 0 indicates that the area in the indicated direction with respect to the reference location is not associated to the SMTC.

In some embodiments, one or multiple reference locations can be provided in a list. In embodiments such as these, each SMTC can be linked to one of the reference locations. A reference location can be indicated similar as the format of the parameter “Ellipsoid-Point.” For instance, each reference location can be identified by an index in the list or an ID, and the index/ID can be configured for a SMTC. Alternatively, in some embodiments, the serving cell reference location provided in SIB19 for cell reselection measurement initiation can be reused. If the serving cell is an earth moving cell, the reference location(s) are given for the epoch time, and the UE can derive the real-time reference location(s) based on serving cell ephemeris. The UE can apply the information when it has a valid UE location, determine the area(s)/direction it is located in with respect to the reference location(s), and apply the associated SMTC(s) to measure the neighbor

### Cells for the Selected Smtc(s).

In some embodiments an SSB bitmap can be provided associated to a SMTC. For an SSB pattern with 4 SSB beams, a 4-bit bitmap can be used (e.g., for FR1-NTN bands). For an SSB pattern with 64 beams, a 64-bit bitmap can be used (e.g., for FR2-NTN bands). In embodiments such as these, a bit of value 1 can indicate that the corresponding SSB index is associated to the SMTC. Similarly, a bit of value 0 can indicate that the corresponding SSB index is not associated to the SMTC. The first/leftmost bit in the bitmap corresponds to SS/PBCH block index 0, the second bit corresponds to SS/PBCH block index 1, and so on. The signaled SSB index (i.e., with bit value 1) indicates the area covered by the corresponding SSB beam. The UE selects an SSB index of the serving cell and applies the associated SMTC(s) to measure the neighbor cells for the selected SMTC(s). The UE can select an SSB index based on the measurements of SSB beams. For example, the UE can select the SSB index of the SSB beam that is measured with the largest L1 SS-RSRP value.

In some embodiments, a UE can report assistance information whenever a certain condition/event is met/triggered. For example, the UE can report the assistance information via a UE Assistance Information procedure and transmit the report in a UE assistance information message, or via a UE Information and transmit the report in a UE information response message as a response to a UE information request message received from the network message, or in a periodic or event-triggered measurement report. The report can be configured/enabled in otherConfig or in a UE information request or in the RRM measurement report configuration.

In some embodiments, the assistance information can be the distance to a configured reference location. In embodiments such as these, the corresponding report trigger condition/event can be the report for the distance to a configured reference location is configured and has not been reported since it was configured or has changed more than a configured threshold compared to the last reported distance to the same reference location.

In some embodiments, the assistance information can be the distance range/level to a configured reference location. In embodiments such as these the corresponding report trigger condition/event can be the report for the distance range/level to a configured reference location is configured and has not been reported since it was configured or has changed compared to the last reported distance range/level to the same reference location.

In some embodiments, the assistance information can be the index/ID of the closest reference location among a list of configured reference locations. In embodiments such as these, the corresponding report trigger condition/event can be the report for the closest reference location is configured and has not been reported since it was configured or has changed compared to the last report.

In some embodiments, the assistance information can be N indices/IDs of reference locations that are in the order of increasing distances to the UE. In embodiments such as these, the corresponding report trigger condition/event can be the report for the list of reference locations' indices/IDs is configured and has not been reported since it was configured, or the closest reference location has changed compared to the last report, or any of the first K report indices/IDs of reference locations from the last report has changed (e.g., K can be a configured value of 2, 3, and so on), or any of the N reported indices/IDs of reference locations from the last report has changed.

In some embodiments, the assistance information can be the index(s)/ID(s) of the selected SMTC(s). In embodiments such as these, the corresponding report trigger condition/event can be the report for the selected SMTC(s) is configured and has not been reported since it was configured or has changed compared to the last report.

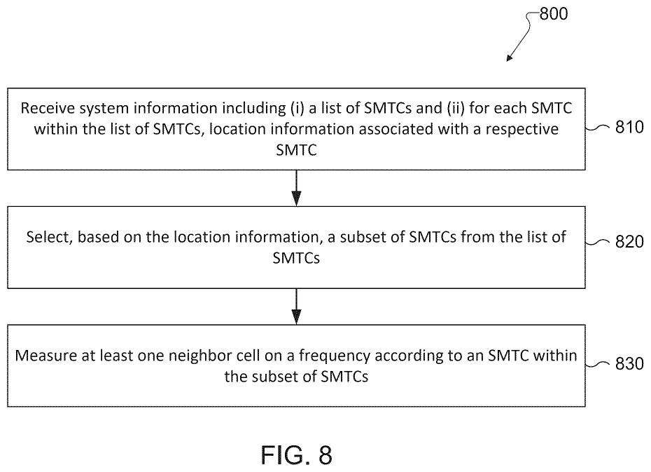

FIG. 8 illustrates an example method for selective measurement of neighbor cells 800 according to embodiments of the present disclosure. An embodiment of the method illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a method for selective measurement of neighbor cells could be used without departing from the scope of this disclosure.

In the example of FIG. 8, the method 800 begins at step 810. At step 810, a UE (such as UE 116 of FIG. 1) receives system information (for example, from a BS such as gNB 102 of FIG. 1). The system information includes (i) a list SMTCs and (ii) for each SMTC within the list of SMTCs, location information associated with a respective SMTC.

In some embodiments, the location information may include information for a reference location. In some embodiments, the information for the reference location may be an index of a reference location in a list of reference locations. In some embodiments, the information for the reference location may indicate that the reference location is a reference location for a serving cell.

At step 820, the UE selects, based on the location information, a subset of SMTCs from the list of SMTCs. At step 830, the UE measures at least one neighbor cell on a frequency according to an SMTC within the subset of SMTCs.

In some embodiments, the UE may further determine that at least one of (i) the UE has not reported information for one or more closest reference locations since being configured to report the information, or (ii) information for the one or more closest reference locations has changed since the UE has reported a most recent measurement report. In embodiments such as these, in response to the determination, the UE may transmit a UE assistance information message including the information for the one or more closest reference locations.

In some embodiments, each SMTC within the list of SMTCs may include an offset parameter associated with a list of physical cell identities (PCIs) of neighbor cells. The offset parameter may be based on an assumption that a base station (BS)-UE propagation delay difference between a serving cell and neighbor cells is equal to zero milliseconds. In embodiments such as these, the method may further include adjusting an actual offset based on an actual BS-UE propagation delay difference between the serving cell and neighbor cells

In some embodiments, the list of SMTCs may be received in a measurement object configuration for measurement in a connected mode. In embodiments such as these, the UE may, for the cells indicated by the list of PCIs in each SMTC within the list of SMTCs, set up an SMTC in accordance with a periodicity and the offset parameter indicated by the respective SMTC

Although FIG. 8 illustrates one example method for selective measurement of neighbor cells 800, various changes may be made to FIG. 8. For example, while shown as a series of steps, various steps in FIG. 8 could overlap, occur in parallel, occur in a different order, occur any number of times, be omitted, or replaced by other steps.

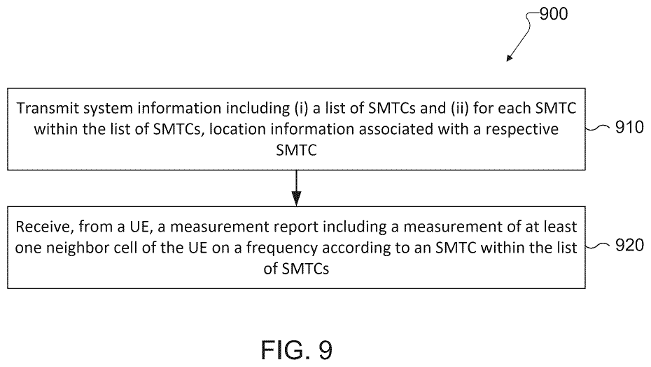

FIG. 9 illustrates another example method for selective measurement of neighbor cells 900 according to embodiments of the present disclosure. An embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a method for selective measurement of neighbor cells could be used without departing from the scope of this disclosure.

In the example of FIG. 9, the method 900 begins at step 910. At step 910, a BS (such as gNB 102 of FIG. 1) transmits system information (for example, to a UE such as UE 116 of FIG. 1) The system information includes (i) a list SMTCs and (ii) for each SMTC within the list of SMTCs, location information associated with a respective SMTC.

In some embodiments, the location information may include information for a reference location. In some embodiments, the information for the reference location may be an index of a reference location in a list of reference locations. In some embodiments, the information for the reference location may indicate that the reference location is a reference location for a serving cell. In some embodiments, the list of SMTCs may be transmitted in a measurement object configuration for measurement in a connected mode.

At step 920, the BS receives, (for example, from the UE) a measurement report including a measurement of at least one neighbor cell of the UE on a frequency according to an SMTC within the list of SMTCs.

In some embodiments, the BS may further receive a UE assistance information message including the information for one or more closest reference locations of the UE.

In some embodiments, the BS may receive a UE assistance information message including the information for one or more closest reference locations of the UE.

Although FIG. 9 illustrates one example method for selective measurement of neighbor cells 900, various changes may be made to FIG. 9. For example, while shown as a series of steps, various steps in FIG. 9 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method of operating a user equipment (UE), the method comprising:
receiving system information including (i) a list of synchronization signal block (SSB) measurement timing configurations (SMTCs), and (ii) for each SMTC within the list of SMTCs, location information associated with a respective SMTC;
selecting, based on the location information, a subset of SMTCs from the list of SMTCs; and
measuring at least one neighbor cell on a frequency according to an SMTC within the subset of SMTCs.

2. The method of claim 1, wherein the location information includes information for a reference location.

3. The method of claim 2, wherein the information for the reference location is an index of a reference location in a list of reference locations.

4. The method of claim 2, wherein the information for the reference location indicates that the reference location is a reference location for a serving cell.

5. The method of claim 2, further comprising:
determining that at least one of (i) the UE has not reported information for one or more closest reference locations since being configured to report the information, or (ii) information for the one or more closest reference locations has changed since the UE has reported a most recent measurement report; and
in response to the determination, transmitting a UE assistance information message including the information for the one or more closest reference locations.

6. The method of claim 1, wherein:
each SMTC within the list of SMTCs includes an offset parameter associated with a list of physical cell identities (PCIs) of neighbor cells;
the offset parameter is based on an assumption that a base station (BS)-UE propagation delay difference between a serving cell and neighbor cells is equal to zero milliseconds; and
the method further comprises adjusting an actual offset based on an actual BS-UE propagation delay difference between the serving cell and neighbor cells.

7. The method of claim 6, wherein:
the list of SMTCs is received in a measurement object configuration for measurement in a connected mode; and
the method further comprises, for cells indicated by the list of PCIs in each SMTC within the list of SMTCs, setting up an SMTC in accordance with a periodicity and the offset parameter indicated by the respective SMTC.

8. A method of operating a base station (BS), the method comprising:
transmitting system information including (i) a list of synchronization signal block (SSB) measurement timing configurations (SMTCs), and (ii) for each SMTC within the list of SMTCs, location information associated with a respective SMTC; and
receiving, from a user equipment (UE), a measurement report including a measurement of at least one neighbor cell of the UE on a frequency according to an SMTC within the list of SMTCs.

9. The method of claim 8, wherein the location information includes information for a reference location.

10. The method of claim 9, wherein the information for the reference location is an index of a reference location in a list of reference locations.

11. The method of claim 9, wherein the information for the reference location indicates that the reference location is a reference location for a serving cell.

12. The method of claim 9, further comprising receiving a UE assistance information message including the information for one or more closest reference locations of the UE.

13. The method of claim 8, wherein the list of SMTCs is transmitted in a measurement object configuration for measurement in a connected mode.

14. An electronic device comprising:
at least one processor including processing circuitry; and
memory storing instructions, wherein the instructions, when executed by the at least one processor individually or collectively, cause the electronic device to:
receive system information including (i) a list of synchronization signal block (SSB) measurement timing configurations (SMTCs), and (ii) for each SMTC within the list of SMTCs, location information associated with a respective SMTC;
select, based on the location information, a subset of SMTCs from the list of SMTCs; and
measure at least one neighbor cell on a frequency according to an SMTC within the subset of SMTCs.

15. The electronic device of claim 14, wherein the location information includes information for a reference location.

16. The electronic device of claim 15, wherein the information for the reference location is an index of a reference location in a list of reference locations.

17. The electronic device of claim 15, wherein the information for the reference location indicates that the reference location is a reference location for a serving cell.

18. The electronic device of claim 15, wherein the instructions, when executed by the at least one processor individually or collectively, further cause the electronic device to:
determine that at least one of (i) the UE has not reported information for one or more closest reference locations since being configured to report the information, or (ii) information for the one or more closest reference locations has changed since the UE has reported a most recent measurement report; and
in response to the determination, transmit a UE assistance information message including the information for the one or more closest reference locations.

19. The electronic device of claim 14, wherein:
each SMTC within the list of SMTCs includes an offset parameter associated with a list of physical cell identities (PCIs) of neighbor cells;
the offset parameter is based on an assumption that a base station (BS)-UE propagation delay difference between a serving cell and neighbor cells is equal to zero milliseconds; and
the instructions, when executed by the at least one processor individually or collectively, further cause the electronic device to adjust an actual offset based on an actual BS-UE propagation delay difference between the serving cell and neighbor cells.

20. The electronic device of claim 19, wherein:
the list of SMTCs is received in a measurement object configuration for measurement in a connected mode; and
the instructions, when executed by the at least one processor individually or collectively, further cause the electronic device to, for cells indicated by the list of PCIs in each SMTC within the list of SMTCs, set up an SMTC in accordance with a periodicity and the offset parameter indicated by the respective SMTC.
